(19) United States
(12) Patent Application Publication
(10) Pub. No.: US 2015/0226867 A1
(43) Pub. Date: Aug. 13, 2015

(54) BEAM STEERED BROADBAND MARINE SURVEY METHOD AND SYSTEM

(71) Applicant: CGG SERVICES SA, Massy Cedex (FR)

(72) Inventor: Hélène Tonchia, Anthony (FR)

(21) Appl. No.: 14/618,224

(22) Filed: Feb. 10, 2015

Related U.S. Application Data
(60) Provisional application No. 61/938,544, filed on Feb. 11, 2014.

(51) Int. Cl. G01V 1/28; G01V 1/18; G01V 1/38

(52) U.S. Cl. CPC G01V 1/28; G01V 1/3808; G01V 1/18; G01V 2210/59

(57) ABSTRACT

A method for improving data resolution in a broad band marine seismic survey. The method includes towing a source array and a receiver array; calculating a non-vertical steering angle to improve a magnitude of a high frequency part of a shallow zone of subsurface reflections that arrive at a selected region of the receiver array over a magnitude of subsurface reflections that would arrive at the selected region of the receiver array for a substantially vertical imaging wave; generating an imaging wave to propagate substantially with the non-vertical steering angle relative to gravity; and recording seismic data corresponding to the imaging wave.

### BACKGROUND

1. Technical Field

The subject matter disclosed herein relates generally to the field of geophysical data acquisition and processing. More particularly, the subject matter relates to the field of geophysical surveys in marine environments.

2. Discussion of the Background

Geophysical data is useful for a variety of applications such as weather and climate forecasting, environmental monitoring, agriculture, mining, and seismology. As the economic benefits of such data have been proven, and additional applications for geophysical data have been discovered and developed, the demand for localized, high-resolution, and cost-effective geophysical data has greatly increased. This trend is expected to continue.

For example, seismic data acquisition and processing may be used to generate a profile (image) of the geophysical structure under the ground (either on land or seabed). While this profile does not provide an exact location for hydrocarbon reservoirs, it suggests, to those trained in the field, the presence or absence of such reservoirs. Thus, providing a high-resolution image of the subsurface of the earth is important, for example, to those who need to determine where hydrocarbon reservoirs are located.

For example, a marine seismic data acquisition system 10 shown in FIGS. 1 and 2 may include a seismic vessel 11 that tows seismic sub-arrays 12 and seismic streamers 13. Although only two seismic sub-arrays 12 and three seismic streamers 13 are shown, this number is for illustrative purposes only. Typically, there can be more seismic sub-arrays 12 and many more seismic streamers 13. The seismic sub-arrays 12 and the seismic streamers 13 are connected to the seismic vessel 11 by cables 14. The cables 14 are typically further connected to devices such as deflectors 15 that spread apart the seismic streamers 13. FIG. 1 shows that the seismic streamers 13 may have equipment attached inline or around the streamers 13. The attached equipment can be, by way of example, in-line mounted position control devices 16, such as depth control devices or lateral control devices, as well as acoustic units and retriever units (not shown). The attached equipment also can be, by way of example, sensors of various types, such as depth sensors and seismic receivers.

As shown in FIG. 2, the seismic vessel 11 tows seismic sub-arrays 12 and seismic streamers 13 under the water surface 20. The seismic sub-arrays 12 primarily comprise floats 21 and sources 22, but may also have equipment such as, for example, near-field sensors (hydrophones) 23 attached adjacent the sources 22. The sources 22 may be impulsive sources, such as air guns, or vibratory sources. The seismic streamers 13 may also have additional equipment attached below the streamers 13. The attached equipment can be, by way of example, suspended position control devices 24 and suspended sensors 25, as well as acoustic units and retriever units (not shown).

In conventional seismic surveys, seismic sources 22 within all sub-arrays 12 that reside at a common depth are simultaneously fired in order to generate an imaging wave that propagates in a substantially vertical direction. As a result, the strongest portions of the imaging wave reflected from a subsurface may not impinge on a receiver array used to record data. FIG. 3 shows that the extents 310 of a typical receiver array, shown with a dashed line on the right half of the polar plot, typically do not coincide with the strongest reflections of the imaging wave. Furthermore, sources at a common depth that are fired simultaneously may have identical imaging notches and a poor response at higher frequencies.

Recently, there have been efforts to improve seismic imaging by broadening the frequency response of the recorded seismic data and using additional high-end frequency components during image processing. Those efforts include using multi-depth sources and receivers that distribute frequency domain notches (due to source-related and receiver-related deconstructive interference) throughout the seismic data spectrum. Specific examples of multi-depth sources and receivers include delta sources (manufactured by WesternGeco), geo sources, slanted streamers, and curved streamers (including proprietary solutions such as BroadSource™ and BroadSeis™ from CGG). Those efforts also include conducting de-ghosting and image processing algorithms that leverage the high frequency data such as those used in the BroadSeis™ solution from CGG. Another way to broaden the signal width on the receiver side is to use multicomponent streamer (see, e.g., U.S. Pat. No. 7,359,283), which can be towed at a given depth. Such a streamer includes at least two different types of sensors for recording the seismic energy.

Applicants have observed that despite various efforts to broaden the frequency response of the recorded seismic data (including those mentioned above), the signal-to-noise ratio of high-frequency seismic data is often poor and limits the effectiveness of such efforts. In response to those observations, Applicants have developed the subject matter disclosed herein.

### SUMMARY

As detailed herein, according to an embodiment there is a method for improving data resolution in a broad band marine seismic survey. The method includes a step of towing a source array and a receiver array; a step of calculating a non-vertical steering angle to improve a magnitude of a high frequency part of a shallow zone of subsurface reflections that arrive at a selected region of the receiver array over a magnitude of subsurface reflections that would arrive at the selected region of the receiver array for a substantially vertical imaging wave; a step of generating an imaging wave to propagate substantially with the non-vertical steering angle relative to gravity; and a step of recording seismic data corresponding to the imaging wave.

According to another embodiment, there is a seismic survey system that includes a source array and a receiver array; and a controller configured to calculate a non-vertical steering angle to improve a magnitude of a high frequency part of a shallow zone of subsurface reflections that arrive at a selected region of the receiver array over a magnitude of subsurface reflections that would arrive at the selected region of the receiver array for a substantially vertical imaging wave. The source array is configured to generate an imaging wave to propagate substantially with the non-vertical steering angle relative to gravity. The receiver array is configured to record seismic data corresponding to the imaging wave.

According to still another embodiment, there is a controller for improving data resolution in a broad band marine seismic survey. The controller includes an interface configured to receive information related to a source array; and a processor connected to the interface. The process is configured to calculate a non-vertical steering angle to improve a magnitude of a high frequency part of a shallow zone of subsurface reflections that arrive at a selected region of a receiver array over a magnitude of subsurface reflections that would arrive at the selected region of the receiver array for a substantially vertical imaging wave, and generate a signal instructing the source array to produce an imaging wave to propagate substantially with the non-vertical steering angle relative to gravity.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1 and 2 are respective top view and side view schematic diagram of conventional marine seismic data acquisition systems;

FIG. 3 is a source directivity plot for a two layers source array in a conventional marine seismic survey;

FIG. 4 is a flowchart of a broadband marine survey method 400 according to one embodiment;

FIGS. 5A-5D depict the relationship between source timing and the steering angle of an imaging wave generated according to the method of FIG. 4;

FIG. 6 is a side view schematic diagram depicting a steered beam for a marine seismic survey conducted according to the method of FIG. 4;

FIG. 7A is a source directivity plot for a source array in a marine seismic survey conducted according to the method of FIG. 4;

FIG. 7B is frequency response plot for seismic data collected without and with beam steering;

FIG. 8 illustrates a seismic acquisition system that targets a shallow zone with a steered beam;

FIG. 9 illustrates a seismic acquisition system that targets a shallow zone with a steered beam and a streamer having single- and multi-component sensors;

FIG. 10 is a source directivity plot for a low frequency of a source array in a marine seismic survey;

FIG. 11 illustrates two layer source signatures for a vertical imaging wave and an imaging wave making an angle with the vertical, both plotted against the time;

FIG. 12 illustrates source signatures of a two layers steered source for a vertical imaging wave and a steered imaging wave plotted against the time;

FIG. 13 illustrates a seismic acquisition system that targets a shallow zone with a steered beam, wherein the shallow zone has a dip;

FIG. 14 illustrates reflected and refracted waves for a seismic acquisition system that targets a shallow zone with a steered beam;

FIGS. 15A-B illustrate a source array having source elements distributed along a line that makes an angle with a horizontal line;

FIG. 16 shows a comparison of a signature of a source with a slanted geometry versus a source with steered beam;

FIG. 17 illustrate another source array having multiple source elements distributed along multiple lines that make an angle with a horizontal line;

FIG. 18 illustrate still another source array for which the source elements are activated with various time delays and distributed with various depth offsets one from the other; and

FIG. 19 is a schematic diagram of a computing device configured to implement a beam steering method according to any of the embodiments discussed herein.

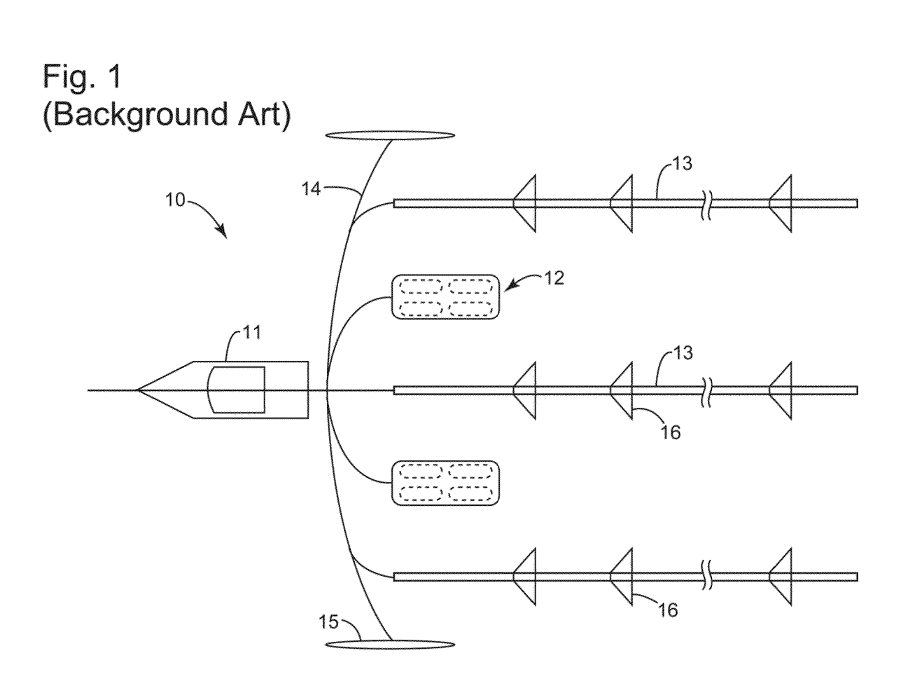

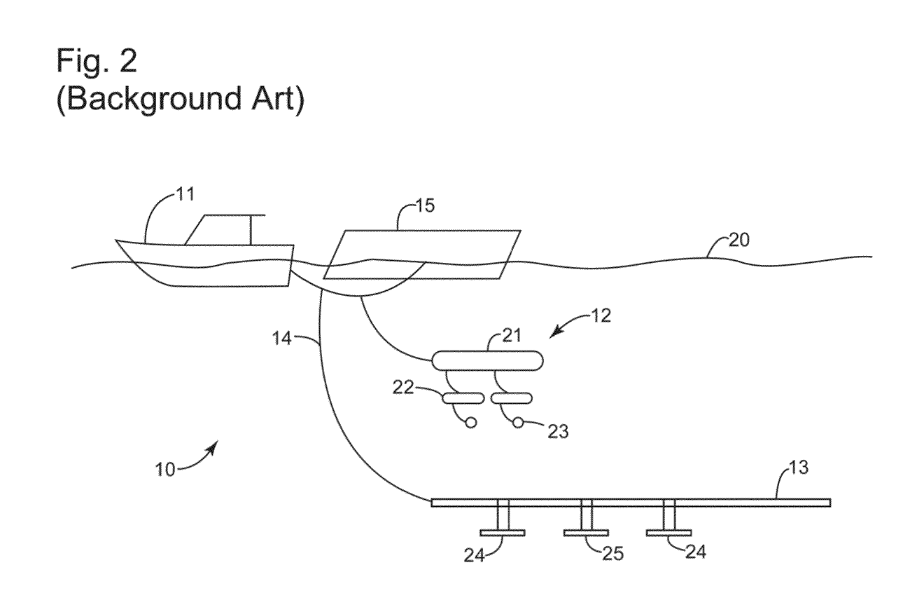

### DETAILED DESCRIPTION

The following description of various embodiments refers to the accompanying drawings. The same reference numbers in different drawings identify the same or similar elements. The following detailed description does not limit the invention. Instead, the scope of the invention is defined by the appended claims. For simplicity, the following embodiments are discussed, in general, with regard to two-dimensional (2D) wave-field propagation. However, the embodiments to be discussed next are not limited to 2D wave-fields, but may be also applied to 3D wave-fields.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

According to one embodiment, a novel method for broadband marine surveys includes firing a plurality of impulsive sources within a towed source array in a selected order and timing and recording reflections of the imaging wave with a receiver array to provide recorded seismic data. The selected order and timing correspond to a substantially planar imaging wave that propagates at a selected non-vertical steering angle. The non-vertical steering angle may be selected (and dynamically adjusted) to maximize subsurface reflections of the imaging wave that arrive at a selected region of the receiver array. In one embodiment, the selected region of the receiver array corresponds to the arrival area of the imaging wave reflected by the first few seconds of the subsurface (i.e., shallow depth) as will be discussed later.

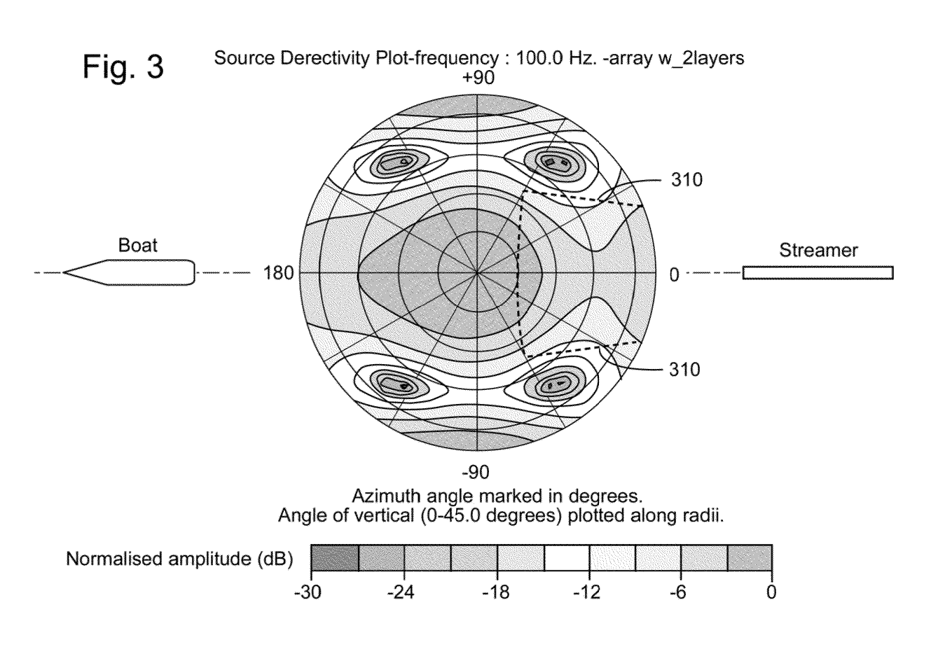

In a general horizontal layout of the geological strata, only the head of the streamers will get reflections from the first seconds of the sub-bottom. However, these reflections may be weak as most of the energy is reflected outside an area including the streamer spread, as discussed above with regard to FIG. 3. Further, the energy sent by the source vertically downward would be reflected upward in front of the streamers, unless there is a dip in the shallow part, as disclosed in U.S. Pat. No. 4,146,870, in which the energy of the source may be directed so as to reflect vertically from a dip formation.

To address this problem, U.S. Pat. No. 5,973,995 proposes using short streamers to image the shallow part of a survey and long streamers for the deepest part. In this patent, two sources are used, one for high frequency to image the shallow part and a deeper one to image the deepest part. With broadband receivers and/or broadband receiver processing and broadband source, the way to do this has totally changed the way a survey is performed as is now possible to image everything in one go.

As will be subsequently explained, using a non-vertical steering angle to determine the selected order and timing of firing for the sources may increase the effective depth diversity of the source array and the receiver array resulting in improved data resolution. A computing device (i.e., apparatus) and system that incorporates the broadband survey method are also described herein. The described method, system, and apparatus may be used to generate improved images of underwater geological structures.

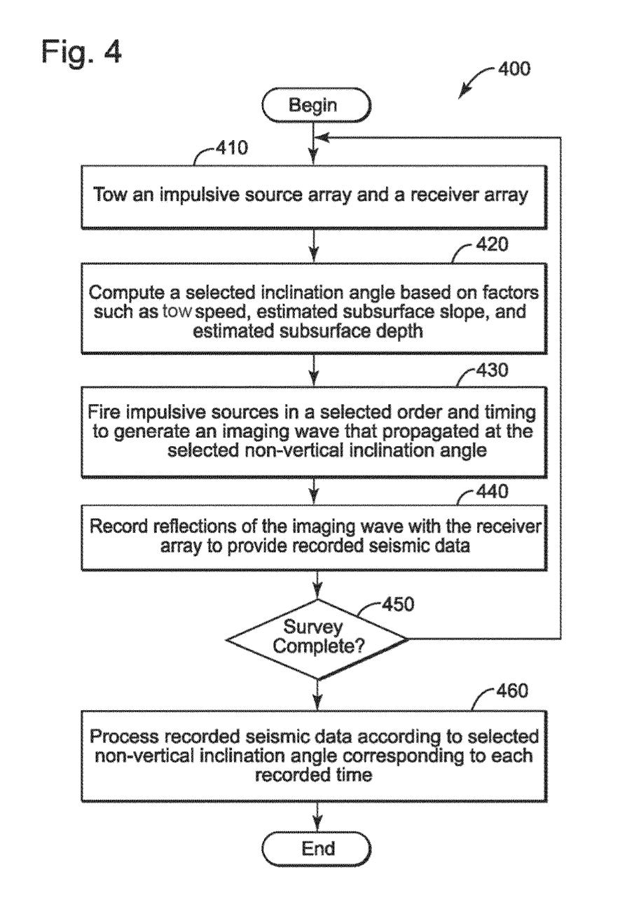

FIG. 4 is a flowchart of a broadband marine survey method 400 according to one embodiment. As depicted, method 400 includes towing (410) an impulsive source array and a receiver array, computing (420) a steering angle for generating an imaging wave with the source array, firing (430) source elements of the source array in a selected order and timing to generate the desired imaging wave, recording (440) reflections of the imaging wave, determining (450) whether a survey is complete, and processing (460) recorded seismic data.

Towing (410) an impulsive source array and a receiver array may include towing a source array and a receiver array (e.g., streamer spread or streamer) with one or more vessels. The source array and the receiver array may be multi-layer arrays with source elements and receiver devices located at multiple depths. The use of multi-layer source arrays reduces ghosting in the resulting images and increase the bandwidth as described in “Synchronized multi-level source and Variable-depth streamer: a combined ghost-free solution for BroadBand marine data,” authored by Ronan Sablon and published at EAGE conference in 2013.

Computing (420) a desired steering angle may include computing a steering angle that will result in a stronger signal being received at a selected region of the receiver array. The selected region of the receiver array may involve one or more of the streamers. For example, the selected region may include a certain number of the seismic receivers distributed along the head portion of each streamer. Other selected regions may be imagined as discussed later. The signal may be selected to correspond to a given frequency range and/or a certain volume from the surveyed subsurface (e.g., the shallow zone of the subsurface). The signal may be induced by reflections of an imaging wave produced by the source array and reflected from the subsurface. A variety of factors may be used in determining the desired steering angle such as, the estimated depth and slope of the subsurface, the frequency range of the signal, etc.

Firing (430) the source elements may include firing a number of impulsive source elements within the source array in a selected order and timing in order to generate an imaging wave that propagates at the desired steering angle. Although the generated imaging wave may not be an ideal planar wave, the selected order and timing may correspond to an ideal planar wave that propagates at the desired steering angle.

The order and timing of firing may also be selected to generate an imaging wave that propagates in a desired azimuthal direction. For example, the order and timing of firing the source elements may be selected to generate an imaging wave that propagates toward a selected region of the receiver array, e.g., the front or central region of the streamer spread. The receiver array may be in-line with the source array or offset from the source array.

Recording (440) reflections of the imaging wave may include recording data with one or more receivers in the receiver array to provide recorded seismic data for the survey. The receivers may reside at multiple depths or a single depth. The receivers may be distributed on horizontal, slanted or curved streamers. Determining (450) whether a survey is complete may include tracking the position of the source array, the receiver array, or a midpoint there between and determining whether a desired survey area has been sufficiently covered. If the survey area has not been sufficiently covered, the method may loop to the towing operation (410). If the survey area has been sufficiently covered, the method may advance to the processing operation (460).

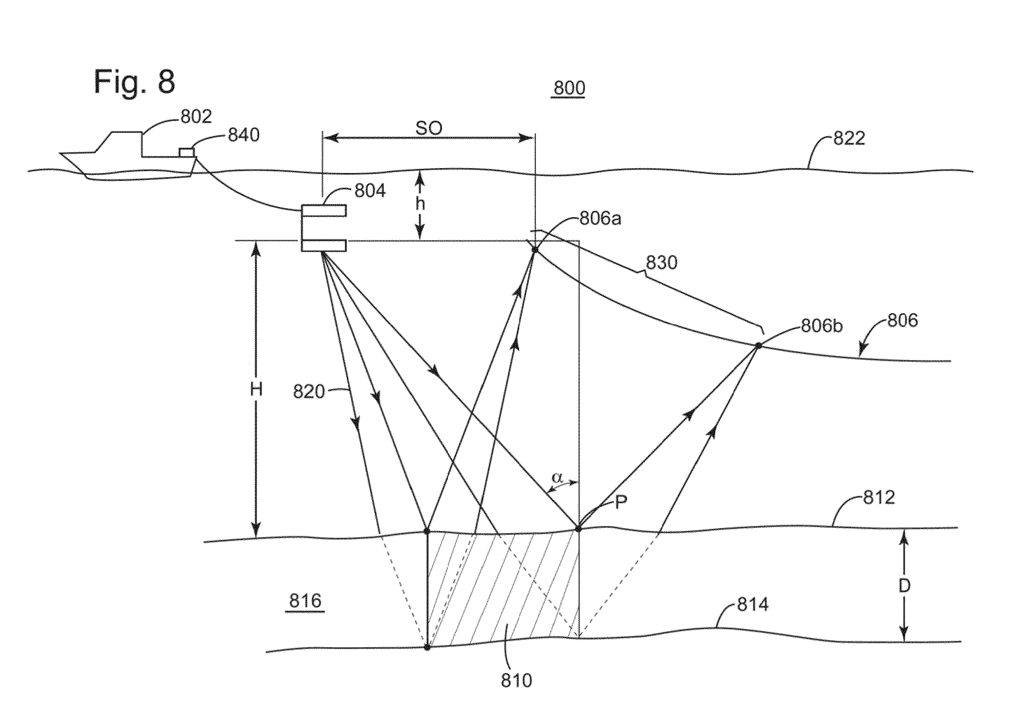

Processing (460) recorded seismic data may include accounting for the selected (typically non-vertical) steering angle. In some embodiments, the selected steering angle is captured with the recorded seismic data. In those embodiments, processing (460) may include changing one or more processing parameters over time to account for the variations in the selected steering angle over time. One or more of the steps of this method may be performed by a controller, as later discussed with regard to FIG. 8.

In some embodiments, a directional de-signature operation taking into account the selected steering angle is conducted as part of the processing operations 460. Alternately, a vertical propagation angle may be assumed for the de-signature operation as is conventionally practiced. In other embodiments, the signature in the direction of the beam may be used, as if it was the vertical one, for a conventional de-signature operation. In certain embodiments, the near-field signals are recorded (for each shot or for one or more representative shots) and used to reconstruct a far-field signature in any direction (angle from the vertical or from the vessel heading) for the de-signature operation either according to the selected steering angle or a vertical propagation angle or for any other given directions and steering angles. For more information on directional de-signature operations see U.S. Provisional Application No. 61/680,823 filed on Aug. 8, 2012, U.S. Provisional Application No. 61/722,901 filed on Nov. 6, 2012, and U.S. Provisional Application No. 61/772,711 filed on Mar. 5, 2013. Each of the aforementioned references are commonly assigned and incorporated herein by reference.

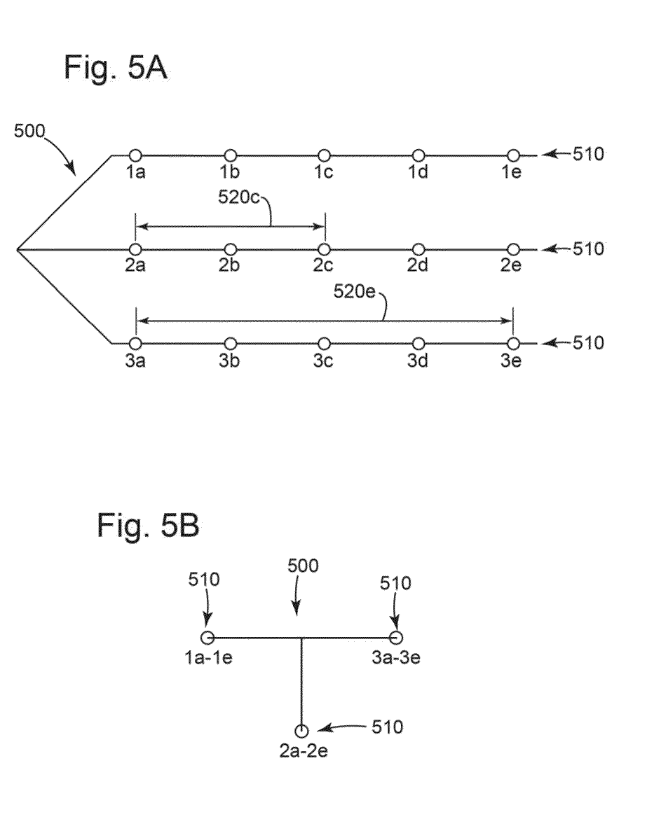

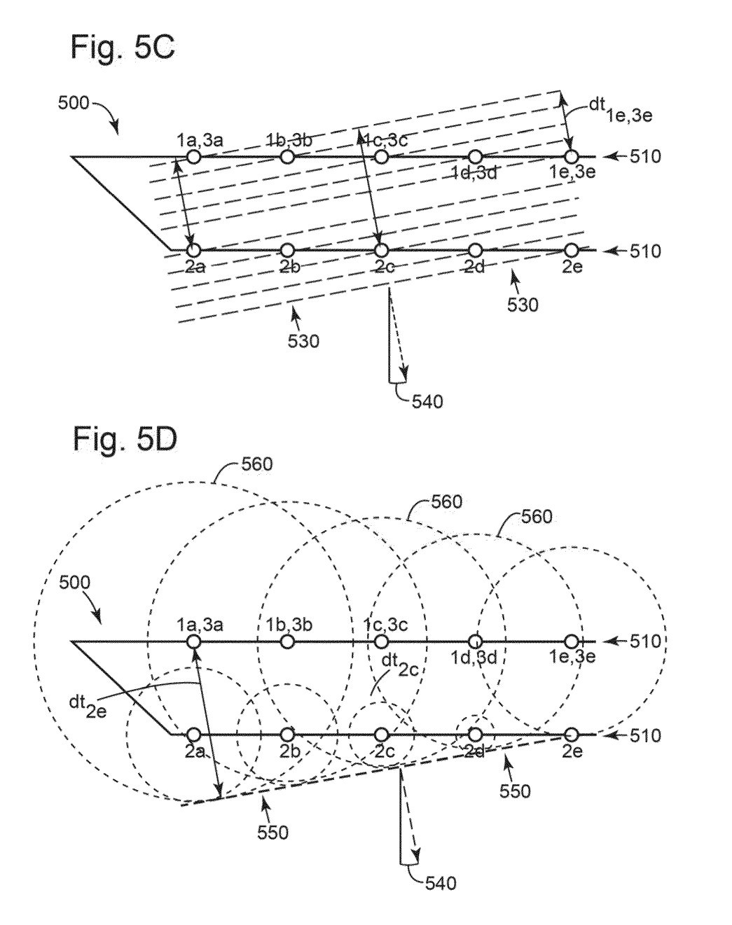

FIGS. 5A-5D depict the relationship between source timing and the steering angle of an imaging wave generated according to the method of FIG. 4 for one particular source array 500. As shown in a top view (FIG. 5A), front view (FIG. 5B), and side view (FIG. 5C), the depicted source array 500 includes a number of source elements 510 arranged in 3 sub-arrays (indexed with numerals 1, 2, and 3) of 5 source elements each at various offsets 520 (indexed with letters a, b, c, d, and e). Each source element 510 is shown with a label that includes both the row index and the offset index (e.g., 1d, 2a, and 3c) to facilitate identification.

FIG. 5C depicts an ideal planar wave 530 that propagates downward at a selected steering angle 540 relative to gravity. The planar wave 530 is assumed to begin at an uppermost source elements 510 or set of source elements 510, relative to the selected steering angle 540, and propagate downward at the selected steering angle 540 at the speed of sound in the particular medium, which in a marine environment is water. In the depicted scenario, source elements 510 with indices 1a and 3a are the uppermost elements. For each of the other source elements 510, there is an associated delay (dt) before the planar wave 530 reaches that particular source element. FIG. 5C depicts the specific delays associated with source elements 510 having index labels 1e, 3e, 2a, and 2c.

As shown in FIG. 5D, an imaging wave 550 that is substantially planar and propagates at the selected steering angle 540 may be generated by firing the source elements in a selected order and timing that correspond to the delays (dt) associated with the ideal planar wave 530. One of skill in the art will appreciate that with vibratory sources, a phase shift between the signals emitted by the source elements 510 is equivalent to a time delay and may be used to generate an imaging wave that propagates at the selected steering angle. Although each source element 510 may generate a substantially spherical wave 560 or the like, the superposition of each of those waves (i.e., sum) may yield an imaging wave 550 that is substantially planar and propagates at the selected steering angle 540.

One of skill in the art may appreciate that the differences between the ideal planar wave 530 and the imaging wave 550 can be reduced with additional source elements 510 within the source array 500 and will also diminish at large distances from the source array 500. Furthermore, propagating the imaging wave 550 at a selected steering angle may increase “an effective depth diversity” experienced by the receiver array in that each receiver in the receiver array that is placed at a common depth will typically receive a reflected version of the imaging wave at a unique time.

Consequently, the receiver notches corresponding to the imaging wave 550 may be distributed across the corresponding imaging spectrum resulting in higher fidelity data. One of skill in the art may also appreciate that a planar wave can be defined by both a steering angle and an azimuthal direction. Consequently, the azimuthal direction of propagation for the imaging wave 550 may also be controlled by selecting a firing order and timing that correspond to a planar wave (whose surface normal is) oriented in the selected azimuthal direction and the selected steering angle.

One of skill in the art will also appreciate that the selected steering angle is depth dependent and that with non-shallow subsurface depths (e.g., depths where the travel time of the imaging wave 550 within the earth is greater than approximately 2 seconds) higher frequency components of the imaging wave 550 may be attenuated to the point that little or no improvement can be attained from processing the higher end of the seismic data spectrum. In such situations it may be expeditious to sub-sample portions of the recorded seismic data corresponding to non-shallow subsurface depths in order to reduce the computation time that is required to process the recorded seismic data. For example, in certain embodiments the sample rate of portions of the recorded seismic data corresponding to non-shallow subsurface depths is reduced from 500 Hz to 250 Hz via sub-sampling and the time required to processing the data is significantly reduced. Furthermore, in some embodiments the portions of the recorded seismic data corresponding to non-shallow subsurface depths are processed according to a vertical steering angle rather the selected non-vertical steering angle in order to reduce processing complexity.

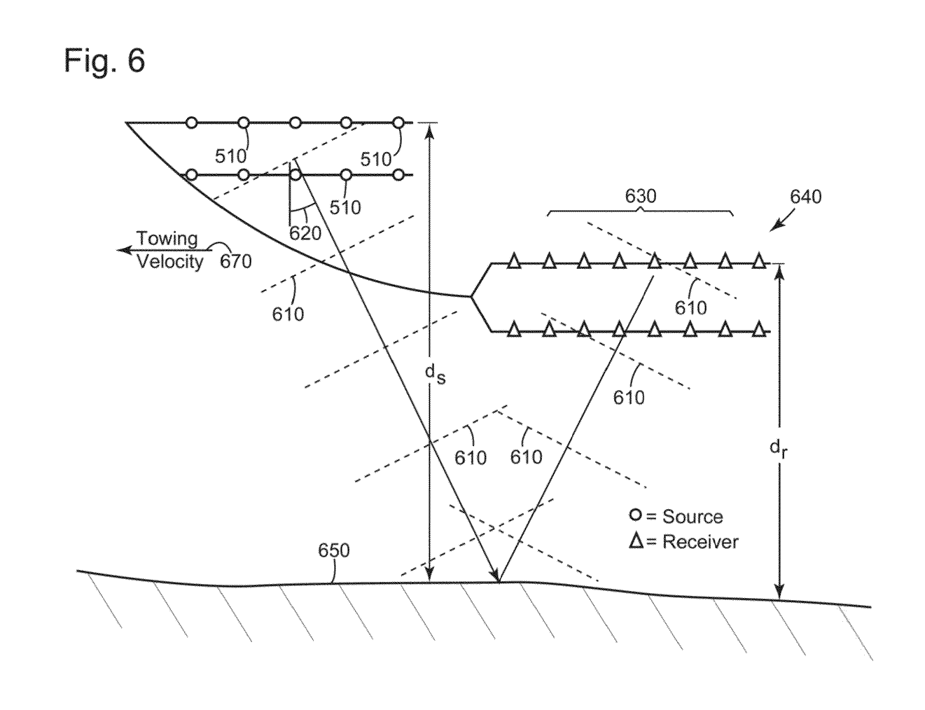

FIG. 6 is a side view schematic diagram depicting a steered imaging wave 610 (i.e., beam) for a marine seismic survey conducted according to the method of FIG. 4. The steered imaging wave 610 may be generated by firing the source elements 510 with a selected order and timing that correspond to a substantially planar wave that propagates at a selected steering angle 620 as well as a selected azimuthal direction (not shown). The steering angle 620 and the azimuthal direction may be selected so that the steered imaging wave 610 (or a strongest portion thereof) impinges primarily on a selected region 630 of a receiver array 640 after being reflected by a subsurface 650. Although FIG. 6 implies that the depicted subsurface 650 is at the water/earth interface, the actual reflecting subsurface 650 may be much lower that the water/earth interface.

The reader may appreciate that the receiver array 640 is essentially a moving target and that the selected steering angle 620 may be dependent on a depth and slope of the subsurface 650, the depth of the source array and the receiver array, a towing velocity 670, as well as other factors such as subsurface currents and the density of the water. Each of these factors may be accounted for in order to maximize the subsurface reflections of the substantially planar imaging wave that arrive at the selected region 630 of the receiver array 640. In one embodiment, selected region 630 is less than half of the entire streamer spread. In another embodiment, selected region 630 is less than 30% of the entire streamer spread. Maximizing the subsurface reflections may increase the signal-to-noise ratio of the recorded seismic data and improve the resolution of the resulting images of the subsurface.

As shown in FIG. 6, both the source array and the receiver array may have multiple depths for individual sources and receivers. Providing multiple depths may provide diversity in the imaging frequency response notches associated with each source and receiver. As a result, the bandwidth of the imaging response may be increased. Furthermore, by generating an imaging wave at a desired steering angle, the effective depths of sources and receivers placed at common depths may be different (relative to the steering angle) resulting in additional diversity (for both multiple depth arrays and single depth arrays) and additional spreading of the notches in the imaging frequency response as well as an increase in bandwidth in the imaging frequency response.

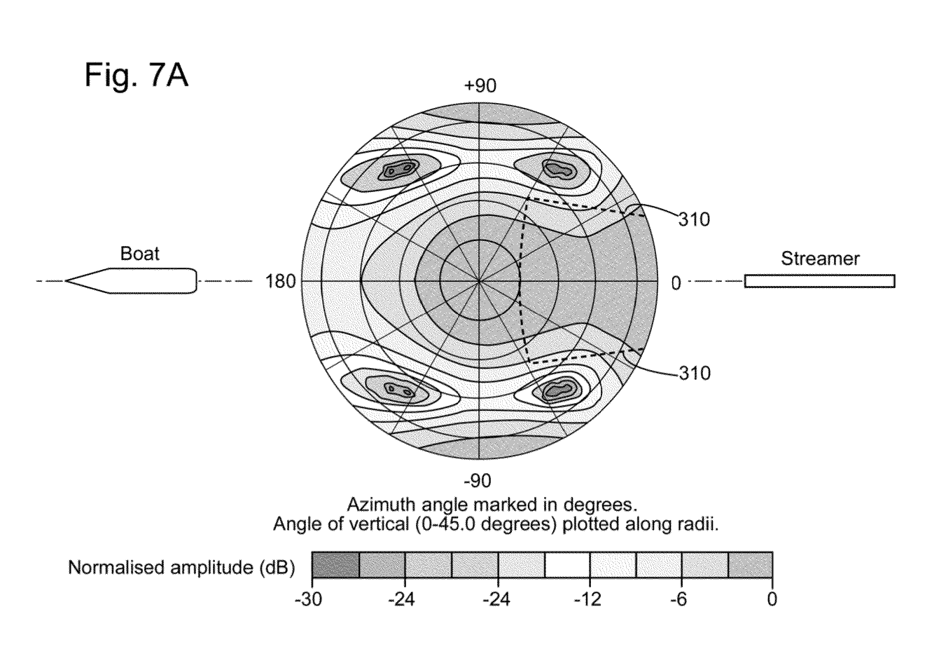

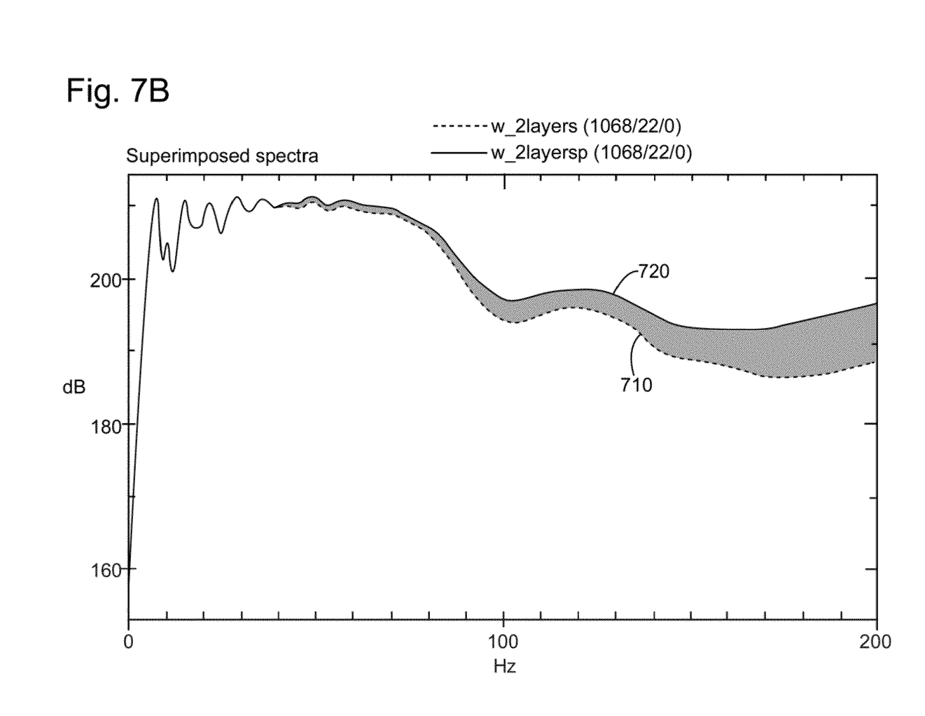

FIG. 7A is a source directivity plot for a source array in a marine seismic survey conducted according to the method of FIG. 4. FIG. 7A shows the relative strength of an imaging wave as a function of the azimuthal angle marked in degrees and the angle of reflection from a subsurface midpoint shown with concentric circles. The dashed line represents the illumination at 500 m as seen from a standard spread and with 200 m between the source and the first receivers. As the notches (low strength due to interfering signals) depends on the frequency, the plot is computed for a given frequency, for example 100 Hz.

In contrast to the directivity plot of FIG. 3, which shows a typical response for prior art approaches, the strongest portions of the imaging wave impinge on the desired region of the receiver array. FIG. 3 has been computed with the same source layout, which is a two levels source, with the same guns at the same positions. The only difference is the angle chosen to steer the beam. Here, in FIG. 7A, the beam is steered toward the streamers while in FIG. 3 it is a vertical beam.

FIG. 7B shows the spectra of the vertical and non-vertically steered two layers source array far-field signature. Those far-field signatures have been modelled at the median angle corresponding to the heads of a BroadSeis streamer. The response curve 710 corresponds to data collected without beam steering while the response curve 720 corresponds to data collected with beam steering. As is shown, beam steering boosts the strength of the recorded seismic data particularly for frequencies above 80 Hz where conventional data collection methods are most deficient. As it is explained further, only a few receivers at the head of the streamers receive the signals used to image the shallow part of the subsurface, and that is the reason why the comparison is significant.

As can be seen on the plot, the low frequencies are not impacted by the beam steering, so using the signature received at the steered angle will improve the high frequency imaging but will not change the deeper, low frequency image.

Applicants have found that beam steering with a source array, according to the methods disclosed herein, can improve a magnitude of subsurface reflections that arrive at a selected region of a receiver array over a magnitude of subsurface reflections that would arrive at the selected region of the receiver array for a substantially vertical imaging wave, such as an imaging wave created by the substantially simultaneous firing of sources at common depths.

In another embodiment, the desired angle is determined as now discussed with regard to FIG. 8. FIG. 8 shows a seismic acquisition system 800 that includes a vessel 802, a source array 804 and a streamer spread 806. Source array 804 includes source elements located at two or more depth levels as schematically illustrated by the figure. The surveyed subsurface of interest, i.e., shallow zone 810, is illustrated as extending from the ocean bottom 812 down to a given interface 814. Shallow zone 810 corresponds to a depth D below the ocean bottom 812. Shallow zone 810 may also extend between two interfaces, none of which is the ocean bottom. In one application, depth D is related to the first two seconds of the seismic data, i.e., data that reflects within two seconds after entering the ocean bottom. In one application, the data is defined by high frequencies, for example, between 100 and 200 Hz. Other values are also possible. The two seconds time interval is exemplary and not intended to limit the size of the shallow zone 810. Note that shallow zone 810 is part of the surveyed subsurface 816, which can extend to about 10 to 15 s of data. However, because the high frequencies are expected to be highly attenuated with depth, the shallow zone is taken to be less than 10 s deep.

Those skilled in the art would note that this embodiment not only selects a desired non-zero steering angle for the imaging wave 820, but this angle is selected and calculated, for example, in controller 840 so that only a certain frequency range (e.g., high frequencies) of the emitted signal is taken into account, for a given shallow zone (e.g., zone 810), and for a selected region 830 of the seismic spread 806. In other words, this embodiment correlates the frequency range of interest with a given zone of the subsurface and with a selected region of the streamer spread for maximizing the recorded seismic data. Controller 840 can be located on vessel 802, on source array 804, in a processing facility onshore, or distributed between two or more of these elements.

Still with regard to FIG. 8, note that in a conventional horizontal layered sea bottom, only the rays from the shallow zone 810 will have high frequencies of good quality for processing. Below this area, the high-frequencies are attenuated. In front of this area, the reflected signals do not reach the receivers and behind this area, as explained further, the signals are refracted instead of being reflected. Thus, in one embodiment, the steering angle for the imaging wave is chosen to maximize the high-frequency in shallow zone 810. The steering angle may be calculated by selecting a point P at the top of the shallow zone 810, as illustrated in FIG. 8, and considering the depth H of the point P relative to the source array 804 and a seismic offset SO between the source array and a first group of receivers 806a in the selected region 830 of the streamer 806. Thus, steering angle α is given by:

tg(α)=SO/H. (1)

Note that the location of point P has been chosen in FIG. 8 to be at the edge of shallow zone 810. In one application, point P may be located at a central position of the top surface of shallow zone 810. In terms of practical considerations, irrespective where point P is located on the top surface of shallow zone 810, it is expected that steering angle α to be substantially constant over the entire shallow zone, considering that a typical value for SO is about 400 m and a depth of the top surface of the shallow zone 810 is about 1000 m. For example, if point P is selected to be about 300 m behind the source and at a depth of about 1000 m, steering angle α is about 15° relative to the gravity. This steering angle is exemplary and those skilled in the art would recognize that the value of the steering angle changes with the geometry of the seismic survey, the point's depth, and other survey parameters. For this specific example, the vessel's operator would have to steer the imaging wave 15° behind the source to maximize the high-frequency content recorded with the selected region 830 of the seismic spread 806. Such beam steering is illustrated in FIGS. 5C and 5D.

Having the steering angle α, a time delay for actuating each source element of the source array may be calculated. For example, consider a source array having a plurality of source elements that extend along an inline direction X, with Dxₙ being a distance from the nth source element to the front of the source. If the sound velocity in water is c, the time delay r for the beam with steering angle α is given by:

$$r = \frac{{Dx}_{n}}{c} \cdot sin α . \qquad ( 2 )$$

Further calculations, based on the actual source modelling (using for example Nucleus software from PGS), ray tracing and/or knowledge of the geology may be performed to help the process of choosing the best angle.

If the source array has two layers of source elements separated by a distance Dz in depth, the shallow layer of source elements are delayed based on equation (2) while the deeper layer shoots with an additional delay rₐ given by:

$${r}_{a} = \frac{Dz}{x} \cdot cos α , \qquad ( 3 )$$

so that the full time delay dt is given by:

$$dt = \frac{{Dx}_{n}}{c} \cdot sin α + \frac{Dz}{c} \cdot cos α . \qquad ( 4 )$$

In one embodiment, the steering angle is adjusted when depth H varies during the survey. A way to implement this dynamic adjustment of the steering angle is to inform the gun's controller to change the delay according to the current depth. A file that stores the correlation between the depth and steering angle may be stored in the air gun's controller or in any storage device of the vessel so that the air gun controller has access to this data. Alternatively, the gun controller may be modified to dynamically calculate the time delays as the depth of the shallow zone changes in time.

Note that FIG. 8 shows streamer 806 having a curved profile, e.g., described by an equation as a circle, parabola, etc. It is also possible that streamer 806 has a linear shape, slanted relative to the water surface 822, with a desired angle β (not shown).

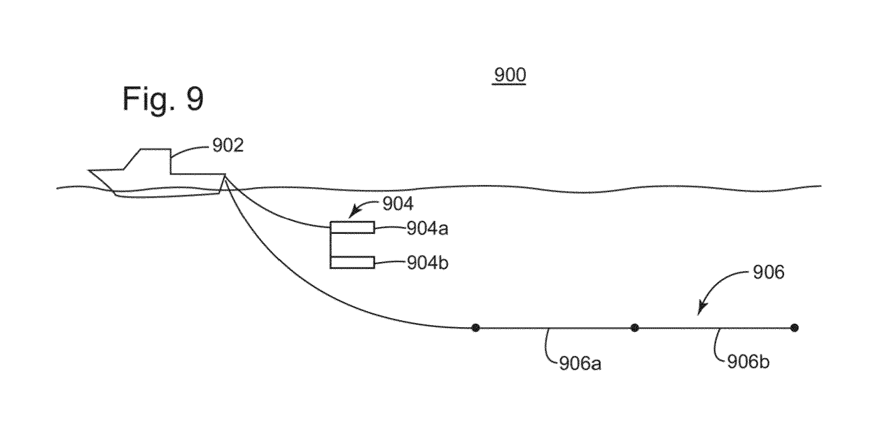

In still another embodiment, FIG. 9 shows another seismic survey system 900 that includes a vessel 902 that tows a source array 904 and horizontal streamers 906. Source array 904 may include two source arrays 904a and 904b that might have different depths, and streamer 906 may include different sections, e.g., a first section 906a having multi-component sensors (see, for example, U.S. Pat. No. 8,477,561 and PCT application number PCT/EP2014/061914) and a second section 906b having single-component sensors. Those skilled in the art would know that streamer 906 may include a plurality of these sections arranged sequentially in any order. However, in one application, the multi-component section 906a is at the front of the streamer. A multi-component sensor may include any kind of sensor as long as the multi-component sensor determines at least two components associated with particle movement, e.g., x and y components of a particle motion, x and z components of a particle acceleration, y component of particle motion and pressure, two pressures at two different locations, etc. A single-component sensor may include any sensor that determines a single component of the particle motion, e.g., pressure.

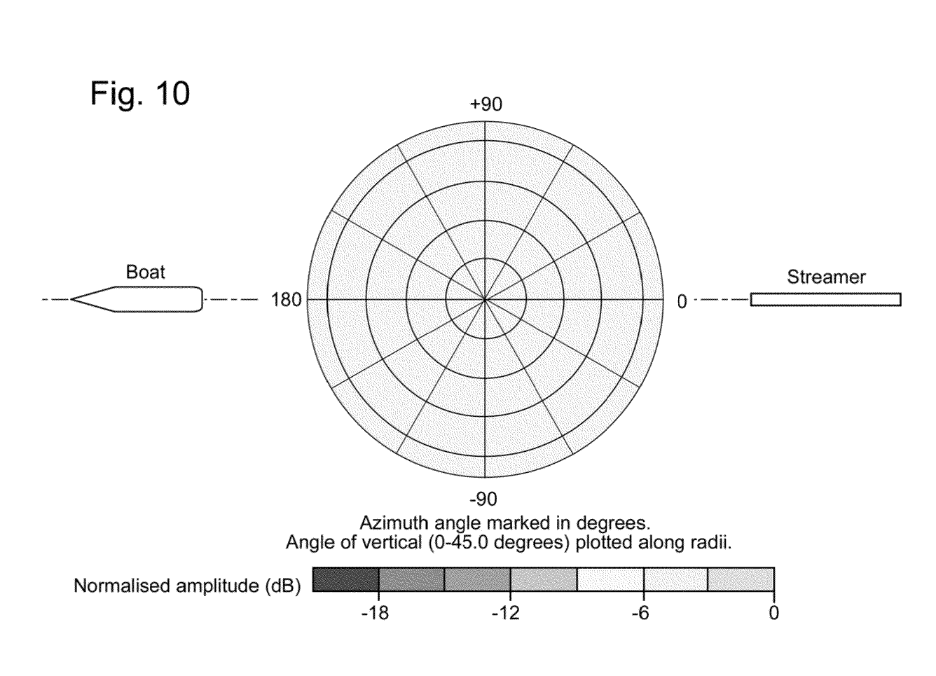

FIG. 7A has shown the source directivity for a source array having two layers of source elements. Note that the plot of FIG. 7A illustrated the source directivity for a frequency of 100 Hz, i.e., a high frequency. However, when the same plot is generated for a frequency of about 5 Hz, i.e., a low frequency, as illustrated in FIG. 10, it is observed that there is no drop of amplitude more than 3 dB. This shows that the low-frequency amplitude does not change for low frequencies, only for high frequencies. This means that this embodiment is relevant for a broad-band source and/or receiver array, as a conventional mono-layer source and standard receiver configuration may not be impacted at all by steering the imaging wave.

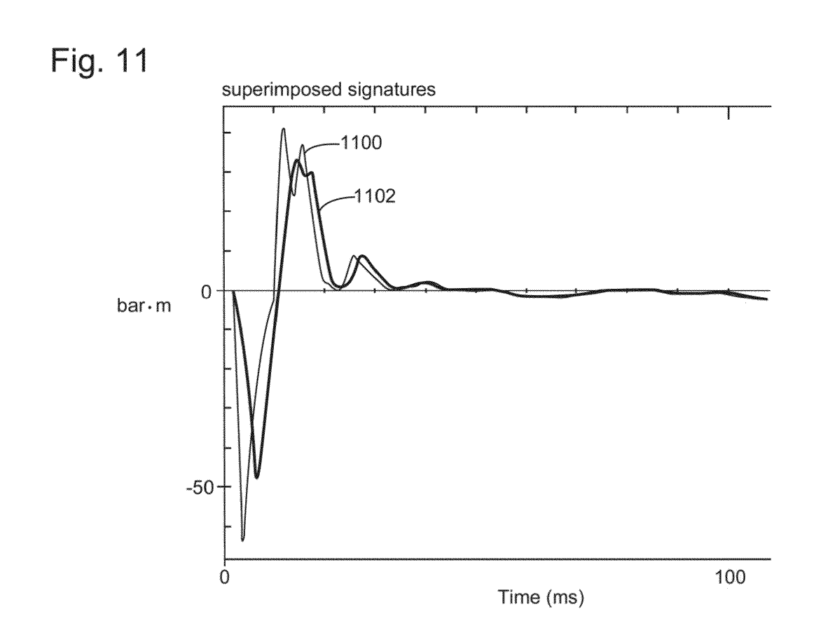

The recorded seismic data may be processed by using a directional de-signature operation or the like. An example of directional de-signature is provided in U.S. Patent Application No. US2014/0043936. A directional de-signature improves the resolution of the shallow part. In a conventional processing sequence, the data is processed using the vertical far-field signature. FIG. 11 shows the far-field signature 1100 of a vertical imaging wave seen in the vertical direction and the far-field signature 1102 as seen at an angle of about 20° versus time. For those two signatures, it is the same two layers source, firing in a conventional way, along the vertical. However, the signal can be recorded in any direction. In each direction the signature is different. The signal recorded from the shallow area with no dip will not come from the vertical, but at an angle. Thus, FIG. 11 shows that signal 1100 at the vertical is sharper, so has a higher content of high frequencies, but it is not used for imaging as this vertical signal is reflected outside of the receivers area. The signal used for imaging is the signal 1102, but it is not as sharp.

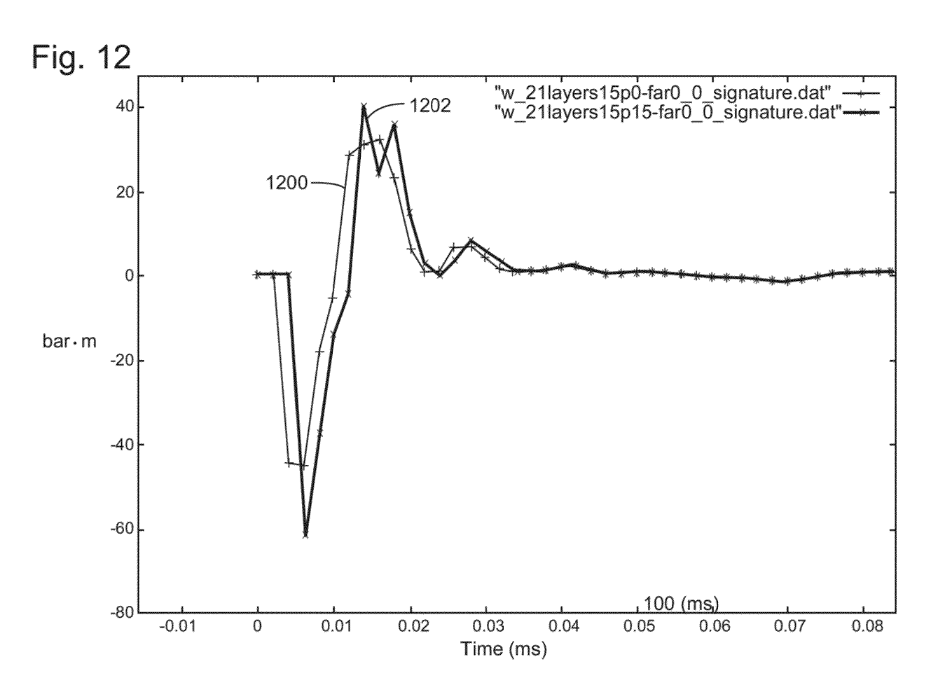

In FIG. 12, the source is steered at a 15° angle, and the far-field signal is observed first in the vertical direction which yields signature 1200, and then it is observed at a 15° angle, which yields the signature 1202. As in FIG. 11, this is a two levels source. Signature 1202 corresponds to the signal reflected in the middle of the shallow zone 810 of the subsurface and recorded in the selected region 830 on the streamers. Signature 1200 corresponds to the signal reflected at the vertical and not recorded as there is no streamer at the vertical of the source. Signature 1202 is sharper than the signature 1200 because it has more high frequencies.

In other words, when the high frequencies are concerned, for a standard horizontal geology, the reflections near the vertical that arrive at the front of the streamers are lost. As the spectrum is the same in the low frequencies, it is better to use the non-vertical signature for a better focused image of the shallow zone of the subsurface.

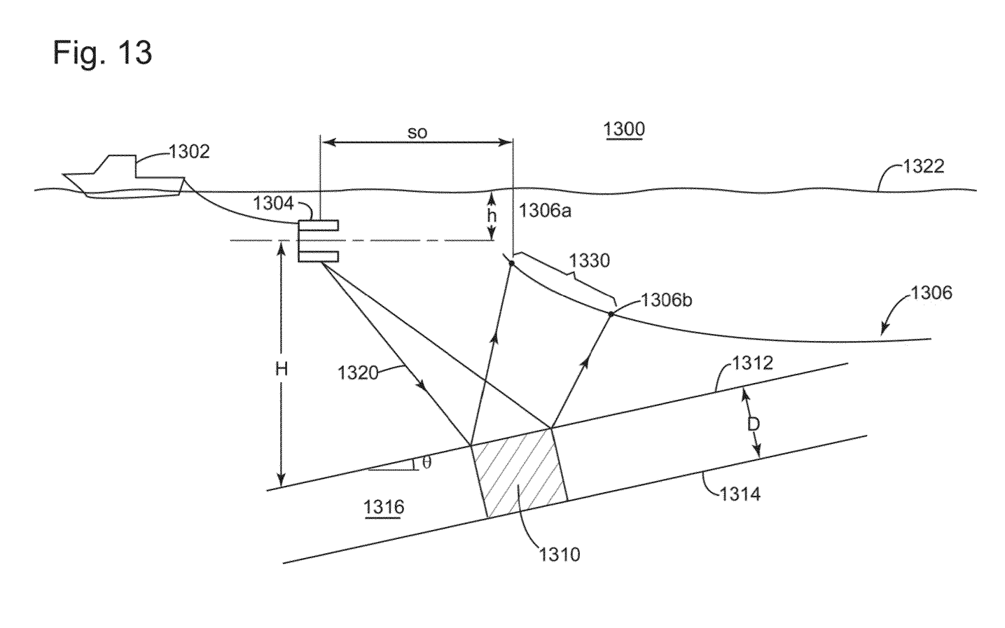

The embodiment discussed with regard to FIG. 8 assumed a horizontal layout of the geological layers, which means that the steering angle has been calculated based only on the seismic offset and the water depth, without taking into account a possible dip angle θ. Using ray tracing as illustrated in FIG. 13, it can be seen that the shallow zone 1310 illuminated and recorded by the front region 1330 of the streamer 1306 is not the same as shallow zone 810 in FIG. 8. Thus, the mean direction of the rays, reaching the front region of the streamer, from the shallow zone of the subsurface is not the same as in the embodiment of FIG. 8. Therefore, the mean new steering angle is greater than the previous one. Thus, instead of steering angle 15° as in the embodiment of FIG. 8, the new steering angle could be now 18°. The new steering angle may be calculated based on experience or on a mathematical model that takes into account dip angle θ, i.e., new steering angle may be given by function f(SO, H, θ), where f is a mathematical function. In this example, the most probable angle of the rays (relative to a dip layer 1312) is different than the one chosen to steer the source, and this most probable angle is the one which should be chosen for the processing of the shallow data in this area.

In other words, when the source is steered, an angle is chosen at which the acoustic wave travels far from the source. When ray tracing is performed to compute where the signals come from in the subsurface, the take-off angle is computed at which the ray leaves the source or the angle at which it reaches the streamer. When directional de-signature is performed, the signature is used at different take-off angles from the source. Thus, in the shallow zones 810 or 1310, the rays correspond to different take-off angles of which none is vertical. Instead of performing a standard directional designature or instead of doing a standard designature using the vertical signature, according to this embodiment, a designature is performed with a signature taken at a take-off angle that better represents the take-off angles of the rays illuminating zones 1310 of 810 than the vertical one.

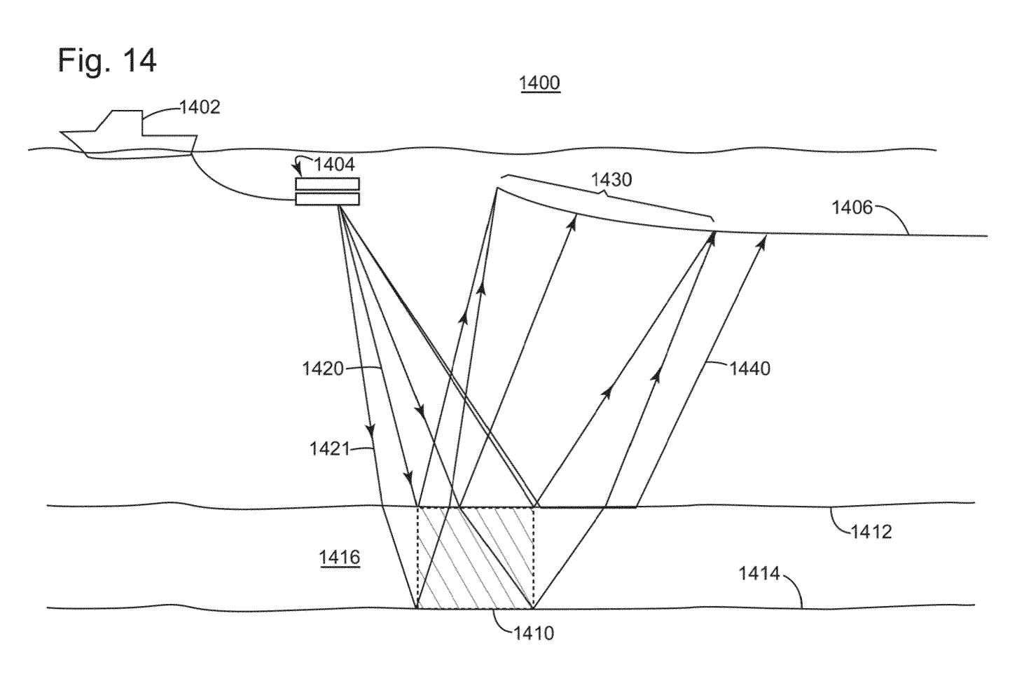

FIG. 14 shows a seismic acquisition system 1400 that includes a vessel 1402 that tows a plural-level seismic source array 1404 and one or more streamers 1406. Although streamer 1406 is shown to have a curved profile, a slanted streamer or a horizontal one may also be used. Imaging waves 1420 and 1421 are shown being reflected from ocean bottom 1412 and at least one other subsurface interface 1414. However, as the angle of incidence on the reflecting structure increases, there is an angle (critical angle) after which all the rays are refracted instead of being reflected. In this respect, ray 1440 illustrates a refracted wave. Although refracted wave 1440 may carry information regarding the shallow zone 1410 of interest, according to this embodiment, only the reflected traces, recorded with seismic sensors located on selected region 1430 of streamer spread, are maintained to image the shallow zone 1410 of the subsurface 1416. In other words, in this embodiment, the refracted waves are not used for imaging the shallow zone 1410.

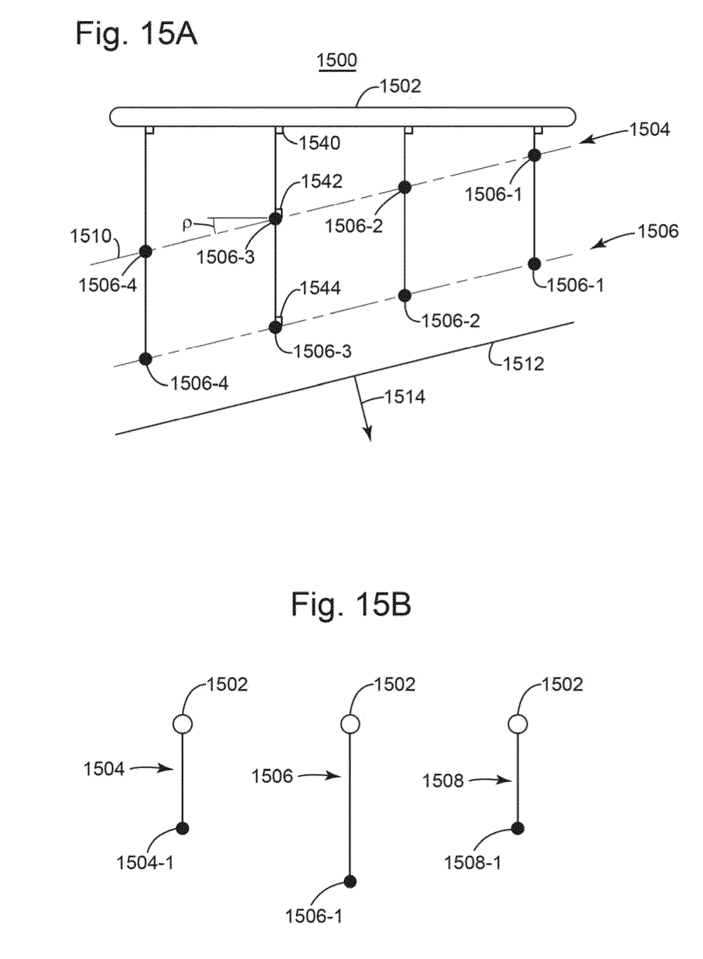

In another embodiment illustrated in FIGS. 15A-B, the source array includes sub-arrays that are slanted relative to the horizontal, which in this case is considered to be the float. More specifically, FIG. 15A shows a source array 1500 having floats 1502 and three sub-arrays 1504, 1506, and 1508, only two being shown in FIG. 15A. FIG. 15B shows all three sub-arrays in a frontal view. Sub-array 1504 has plural source elements 1504-1 to 1504-4 distributed along the corresponding float 1502. Note that sub-array 1504 has its source elements 1504-1 to 1504-4 distributed along a slanted line 1510. In one embodiment, only one sub-array has its source elements located along a slanted line. In another embodiment, all the sub-arrays are slanted. In still another embodiment, line 1510 is curved for one or more of the sub-arrays, e.g., a parabola, a circle, etc.

In one embodiment, slanted line 1510 is calculated (i.e., its angle φ with a horizontal line) so that it is substantially perpendicular on a desired direction of the imaging wave 1514. FIG. 15A shows imaging wave direction 1514 and imaging wave 1512. In this way, there is no need to steer the imaging wave by delaying the shooting of the various source elements as discussed above with regard to the embodiment of FIGS. 5A-D. In other words, for steering the imaging wave, it is possible according to this embodiment to slant the geometry of the source array instead of controlling the shooting times for the source elements. For practical reasons, an existing sub-array may not be slanted with an angle larger than 11°. Thus, if a steering angle of 20° is necessary to be achieved, it is either possible to build a new source with such a large slant angle, or the multilevel source elements are triggered with calculated delay times for achieving this angle.

However, in another embodiment, is it possible to combine the slanted location of the source elements with the delayed triggering, so that up to 11° of the steering angle is achieved with the slanted geometry and the remaining angle is achieved with the delayed triggering of the source elements. In other words, the steering angle may be obtained as a combination of slanting the geometry of the sub-arrays and delay triggering the individual source elements. In one application, as discussed above with regard to FIGS. 5A-D, the desired steering angle is achieved only by implementing the delay triggering of the source elements. In another application, as discussed above with regard to FIG. 15A, the desired steering angle may be achieved only by implementing the slanted geometry of the source array.

To achieve a desired slanted or curved geometry for one or more sub-arrays, actuation devices (e.g., winches) may be mounted either on the float or on each source element, as illustrated in FIG. 15A with reference numbers 1540, 1542, and 1544. In this way each source element may be adjusted to have a desired depth to achieve the slanted or curved geometry. Note that a sub-array may have the actuation devices positioned at one or more of the locations indicated in FIG. 15A. Also note that one sub-array may be located at a given depth while another sub-array may be located to another depth. In this respect, FIG. 15B is a frontal view of source array 1500 having three sub-arrays 1504, 1506 and 1508. Each sub-array may have its own float 1502. FIG. 15B shows only the first source element of each sub-array. Middle sub-array 1506 is shown being deeper than side sub-arrays 1504 and 1508. Other depth configurations are possible for each sub-array. The adjustment of the source geometry discussed above may be performed at the beginning of the survey, but also during the survey (dynamic adjustment) as the conditions of the survey require.

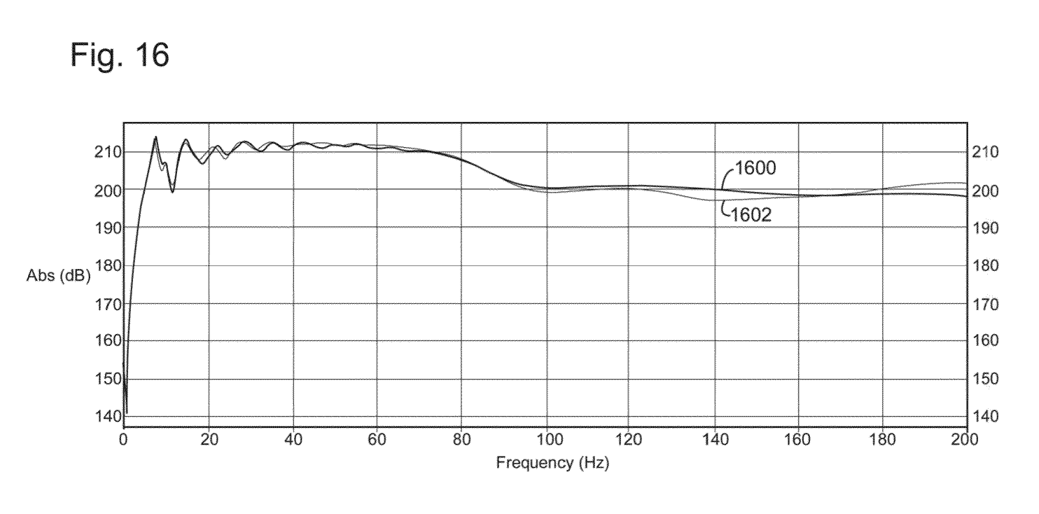

FIG. 16 shows the source signature 1600 for a source array having a slanted geometry of about 11° and no beam steering and the source signature 1602 for a source array with horizontal geometry (no slant) and beam steering of about 11°. A gain in the amplitude is observed in the 100-150 Hz band.

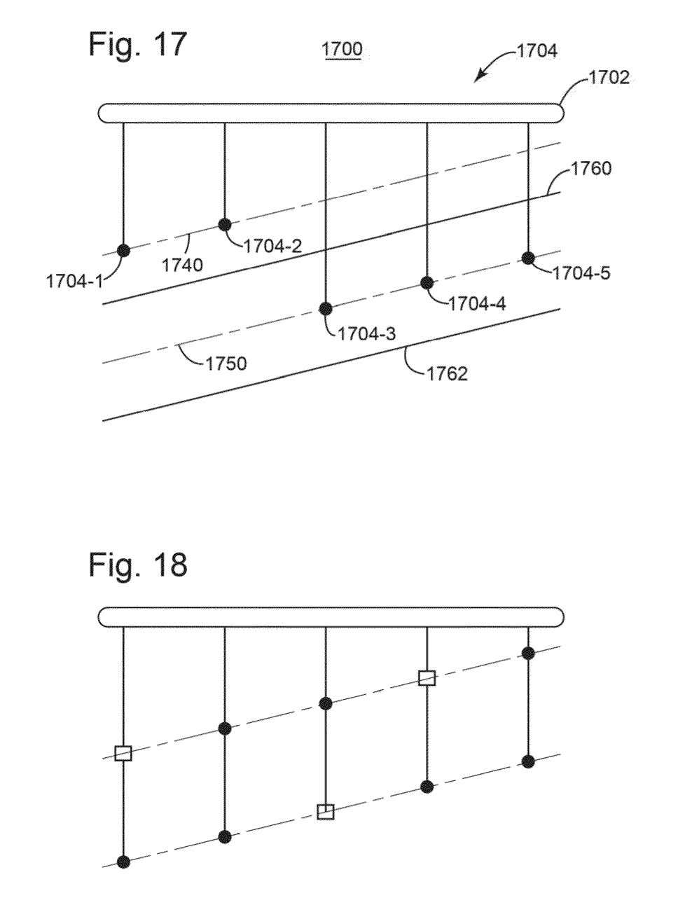

A variation of the embodiment illustrated in FIG. 15A has the source elements of a same sub-array distributed at different levels, as illustrated in FIG. 17, i.e., at least one subset of source elements 1704-1 and 1704-2 distributed along a first line 1740 and another subset of source elements 1704-3 to 1704-5 distributed along a second line 1750. The two lines 1740 and 1750 may be straight or curved. If lines 1740 and 1750 are straight as shown in FIG. 17, an imaging wave 1760 is formed first by triggering the first subset and then, the second subset is triggered to boost energy of the imaging wave, which is now shown as 1762. In one embodiment, time delay corrections are not implemented. In another embodiment illustrated in FIG. 18, time corrections are implemented to the source elements identified by a square and not to the source elements identified by a circle. Other combinations of time delays to be applied to the source elements may be imagined.

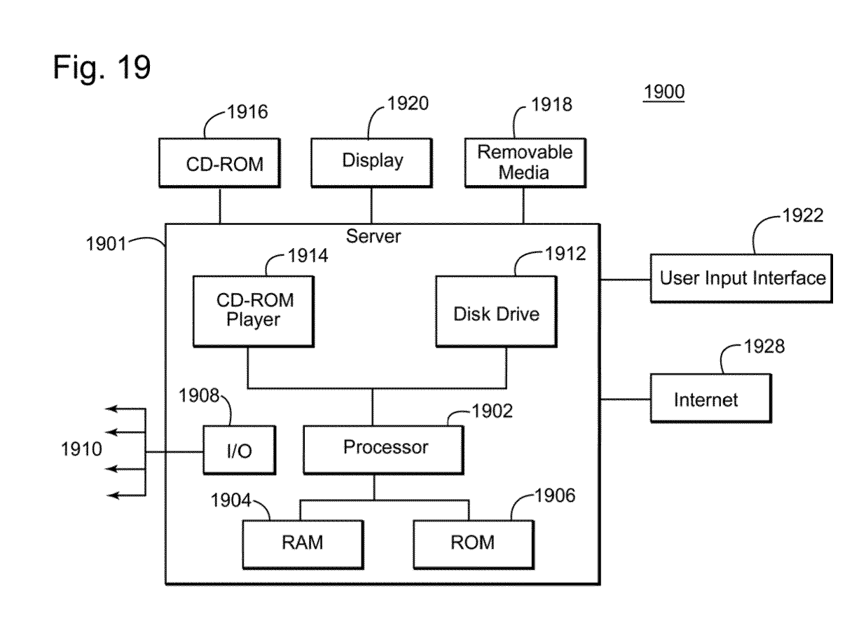

The above-discussed procedures and methods may be implemented in one or more computing similar to the computing device 1900 illustrated in FIG. 19. In one embodiment, computing device 1900 is controller 840. Hardware, firmware, software, or a combination thereof may be used to perform the various steps and operations described herein. The computing device 1900 of FIG. 19 is an exemplary computing structure that may be used in connection with a broadband marine seismic survey system or the like.

The exemplary computing device 1900 suitable for performing the activities described in the exemplary embodiments may include a server 1901. Such a server 1901 may include a central processor (CPU) 1902 coupled to a random access memory (RAM) 1904 and to a read only memory (ROM) 1906. The ROM 1906 may also be other types of storage media to store programs, such as programmable ROM (PROM), erasable PROM (EPROM), etc. The processor 1902 may communicate with other internal and external components through input/output (I/O) circuitry 1908 and bussing 1910, to provide control signals and the like. Interface 1908 is configured to receive information about the seismic system, for example, characteristics of the seismic source, e.g., its geometry, the number of source elements, their volumes, etc. The processor 1902 carries out a variety of functions, as are known in the art, as dictated by software and/or firmware instructions.

The server 1901 may also include one or more data storage devices, including hard drives 1912, CDDROM drives 1914, and other hardware capable of reading and/or storing information such as DVD, etc. In one embodiment, software for carrying out the above-discussed steps may be stored and distributed on a CDDROM or DVD 1916, a USB storage device 1918 or other form of media capable of portably storing information. These storage media may be inserted into, and read by, devices such as the CDDROM drive 1914, the disk drive 1912, etc. The server 1901 may be coupled to a display 1920, which may be any type of known display or presentation screen, such as LCD displays, plasma display, cathode ray tubes (CRT), etc. A user input interface 1922 is provided, including one or more user interface mechanisms such as a mouse, keyboard, microphone, touchpad, touch screen, voice-recognition system, etc.

The server 1901 may be coupled to other devices, such as sources, detectors, etc. The server may be part of a larger network configuration as in a global area network (GAN) such as the Internet 1928, which allows ultimate connection to the various landline and/or mobile computing devices.

It should be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for improving data resolution in a broad band marine seismic survey, the method comprising:
towing a source array and a receiver array;
calculating a non-vertical steering angle to improve a magnitude of a high frequency part of a shallow zone of subsurface reflections that arrive at a selected region of the receiver array over a magnitude of subsurface reflections that would arrive at the selected region of the receiver array for a substantially vertical imaging wave;
generating an imaging wave to propagate substantially with the non-vertical steering angle relative to gravity; and
recording seismic data corresponding to the imaging wave.

2. The method of claim 1, wherein the imaging wave is generated in response to firing a plurality of source elements in the source array in a selected order and timing that corresponds to a substantially planar imaging wave propagating at the selected non-vertical steering angle.

3. The method of claim 1, wherein the non-vertical steering angle is selected to maximize the high-frequency magnitude of subsurface reflections that arrive at the selected region of the receiver array.

4. The method of claim 3, wherein the selected region is a front portion of the receiver array.

5. The method of claim 1, wherein the selected non-vertical steering angle varies with a depth of the shallow zone and/or with a dip angle of the shallow zone.

6. The method of claim 2, wherein the selected order and timing corresponds to a substantially planar imaging wave that propagates in a selected azimuthal direction.

7. The method of claim 1, wherein the source array comprises several sub-arrays, at least one sub-array having its source elements located along an imaginary line that is slanted or curved relative to the water surface.

8. The method of claim 1, wherein the receiver array includes at least one streamer having a variable-depth profile.

9. The method of claim 1, wherein the receiver array includes at least one streamer having a first multicomponent section closest to the source array.

10. The method of claim 1, further comprising:
calculating the non-vertical steering angle based on a depth of a top surface of the shallow zone and a seismic offset between the source array and the selected region.

11. The method of claim 1, further comprising:
calculating the non-vertical steering angle based on a dip of the shallow zone.

12. The method of claim 1, further comprising:
arranging source elements of the source array along an imaginary line that is slanted or curved relative to the water surface; and
generating the imaging wave to have the non-vertical steering angle at least equal to an angle made between the imaginary line and the water surface.

13. The method of claim 12, wherein the non-vertical steering angle is achieved partially by a slanted geometry of the source array and partially by firing the source elements in a selected order and with a delay timing sequence.

14. The method of claim 1, further comprising:
selecting the non-vertical steering angle to improve a magnitude of high frequencies acquired by the streamers; and
processing at least a portion of the seismic data with an improved high-frequency content according to the selected non-vertical steering angle.

15. The method of claim 1, further comprising:
selecting the non-vertical steering angle to improve a magnitude of the high frequencies acquired by near-offset sensors in the streamers; and
processing at least a portion of the data with an improved high-frequency content using a most probable signature according to this portion of data and the non-vertical steering angle.

16. A seismic survey system comprising:
a source array and a receiver array; and
a controller configured to calculate a non-vertical steering angle to improve a magnitude of a high frequency part of a shallow zone of subsurface reflections that arrive at a selected region of the receiver array over a magnitude of subsurface reflections that would arrive at the selected region of the receiver array for a substantially vertical imaging wave,
wherein the source array is configured to generate an imaging wave to propagate substantially with the non-vertical steering angle relative to gravity, and
the receiver array is configured to record seismic data corresponding to the imaging wave.

17. The system of claim 16, wherein the imaging wave is generated in response to firing a plurality of source elements in the source array in a selected order and timing that corresponds to a substantially planar imaging wave propagating at the selected non-vertical steering angle.

18. The system of claim 1, wherein the non-vertical steering angle is selected to maximize the high-frequency magnitude of subsurface reflections that arrive at the selected region of the receiver array.

19. The system of claim 18, wherein the selected region is a front portion of the receiver array.

20. A controller for improving data resolution in a broad band marine seismic survey, the controller comprising:
an interface configured to receive information related to a source array; and
a processor connected to the interface and configured to,
calculate a non-vertical steering angle to improve a magnitude of a high frequency part of a shallow zone of subsurface reflections that arrive at a selected region of a receiver array over a magnitude of subsurface reflections that would arrive at the selected region of the receiver array for a substantially vertical imaging wave, and
generate a signal instructing the source array to produce an imaging wave to propagate substantially with the non-vertical steering angle relative to gravity.
